(19) United States
(12) Patent Application Publication
(10) Pub. No.: US 2012/0023214 A1
(43) Pub. Date: Jan. 26, 2012

(54) SYSTEM AND METHOD FOR STATE TRANSITION OF A LOAD CONTROLLER DEVICE

(75) Inventors: David S. Leeds, Lake Worth, FL (US); Christopher C. Jones, San Francisco, CA (US); David W. Killian, Lake Worth, FL (US); Joshua A. Bass, Parkland, FL (US)

(73) Assignee: OPENPEAK INC., Boca Raton, FL (US)

(21) Appl. No.: 13/178,306

(22) Filed: Jul. 7, 2011

Related U.S. Application Data
(60) Provisional application No. 61/366,296, filed on Jul. 21, 2010.

(51) Int. Cl. G06F 15/173

(52) U.S. Cl. 709/223

(57) ABSTRACT

A method of facilitating wireless communications between a load controller device and a network component is described. The method can include the step of transitioning the load controller device from a peer-to-peer state in which the load controller device can receive initialization information to a provisioned state in which the load controller device connects to the network component using the initialization information. If there is a disruption in the connection between the load controller device and the network component in the provisioned state, the load controller device can be forced back to the peer-to-peer state from the provisioned state to enable the load controller device to receive new initialization information for reestablishment of the connection between the load controller device and the network component or for establishment of another connection between the load controller device and a different network component.

### CROSS-REFERENCE TO RELATED APPLICATIONS

This application claims priority to U.S. Provisional Patent Application No. 61/366,296, filed Jul. 21, 2010 and entitled “System and Method for State Transition of a Load Controller Device,” the entirety of which is incorporated by reference herein.

### FIELD OF TECHNOLOGY

The subject matter disclosed herein is direct to different states of a sensor and, more particularly, to systems and methods for transitioning between such states.

### BACKGROUND

Many communication networks rely on Internet Protocol (IP) to exchange voice and data between devices. For example, W-Fi networks, which operate in accordance with IP, have become popular in both residential and commercial environments. In a typical Wi-Fi network, one or more access points (APs) are strategically positioned in a building or a home, and numerous devices may be wirelessly connected to the network through the APs. Before a Wi-Fi-enabled device can be connected to the network, however, an initialization process must be carried out. For example, such a device should be provisioned with several Wi-Fi network parameters prior to the attempted network connection. Once the initialization is complete, the device should connect to the Wi-Fi network through an AP during the next and subsequent power-up cycles or simply attempt to connect as a last step of the initialization process.

Notably, however, the AP through which the device connects to reach the network may become corrupted or damaged in some way or simply replaced if a user thereof wishes to upgrade. In this state, the AP is no longer a suitable means by which the device can access the Wi-Fi network. Nevertheless, due to the way the device was provisioned during the initialization process, the device may continue to attempt to connect to the network through the compromised AP, which can lead to frustration on the part of users of the device and the network.

### SUMMARY

A method of facilitating wireless communications between a load controller device and a network component is described herein. The method can include the step of transitioning the load controller device from a peer-to-peer state in which the load controller device can receive initialization information to a provisioned state in which the load controller device can establish a connection to the network component using the initialization information.

If there is a disruption in the connection between the load controller device and the network component in the provisioned state, the load controller device can be forced back to the peer-to-peer state from the provisioned state to enable the load controller device to receive new initialization information. This process can help establish the connection between the load controller device and the network component or establish another connection between the load controller device and a different network component.

The foregoing method can also include the step of transitioning the load controller device to the provisioned state for connection to the network component or the different network component following the receipt of the new initialization information by the load controller device. An indicator can also be selectively activated to enable an operator to determine whether the load controller device is in the peer-to-peer state or the provisioned state. As an example, selectively activating an indicator can include selectively illuminating a light source in which one or more illumination patterns or colors are used to enable the operator to distinguish between the peer-to-peer state and the provisioned state.

In one arrangement, the peer-to-peer state can include a reset state, a peer-to-peer ready state and a peer-to-peer connected state. Forcing the load controller device back to the peer-to-peer state from the provisioned state can include forcing the load controller device to the reset state to delete initialization information of the load controller device. In addition, the method can include the step of broadcasting connection information from the load controller device to a facilitation unit when the load controller device is in the peer-to-peer ready state. A connection can be established between the load controller device and the facilitation unit while the load controller device is in the peer-to-peer ready state. When the load controller device is connected to the facilitation unit, the load controller device can be moved to the peer-to-peer connected state and can receive the new initialization information from the facilitation unit in the peer-to-peer connected state.

In another arrangement, the provisioned state can be made up of a provisioned ready state and a provisioned connected state. In accordance with such an arrangement, the method can further include the step of receiving a signal at the load controller device from a facilitation unit directing the load controller device to reestablish the connection to the network component in the provisioned ready state. Alternatively, the signal can direct the load controller device to establish the other connection to the different network component in the provisioned ready state. The load controller device can be moved to the provisioned connected state when the connection between the load controller device and the network component is reestablished or when the connection between the load controller device and the different network component is established.

As an example, the load controller device can engage an outlet and a load that is configured to receive power from the outlet. The load controller device can provide at least some power that is received from the outlet to the load. The load controller device can selectively control or monitor the amount of power provided to the load.

A load controller device is also described herein. The load controller device can include a prong configured to engage an external receptacle and to receive power therefrom, an internal receptacle configured to engage a load and to provide power thereto, and a load controller circuit configured to control or monitor the power provided to the load. The load controller device can also include a communication unit coupled to the load controller circuit and configured to connect with a facilitation module in a peer-to-peer state and connect with a network component in a provisioned state. In one aspect, the communication unit can be further configured to transition the load controller device from the provisioned state to the peer-to-peer state to enable the load controller device to receive initialization information for reestablishment of the connection between the load controller device and the network component. The initialization information can also be used for establishment of a connection between the load controller device and a different network component.

The communication unit can be further configured to transition the load controller device from the provisioned state to the peer-to-peer state if there is a disruption in the connection between the communication unit and the network component. The load controller device can also include an indicator configured to alert a user as to whether the load controller device is in the peer-to-peer state or the provisioned state. As an example, the indicator can be a light source, which can be selectively illuminated in accordance with a predetermined pattern to enable the user to distinguish between the peer-to-peer state and the provisioned state.

The communication unit can be further configured to broadcast connection information about the load controller device when the load controller device is in the peer-to-peer state. As an example, the peer-to-peer state can include a peer-to-peer ready state and a peer-to-peer connected state. The communication unit can broadcast the connection information in the peer-to-peer ready state and can be connected to the facilitation module in the peer-to-peer connected state. The initialization information can be received by the load controller device in the peer-to-peer connected state.

In another aspect, the provisioned state can include a provisioned ready state and a provisioned connected state. The load controller device can attempt to connect to the network component or the different network component in the provisioned ready state and can be connected to the network component or the different network component in the provisioned connected state. The load controller device can also have a switch in which activating the switch can cause the communication unit to transition the load controller device from the provisioned state to the peer-to-peer state.

A method of interrupting a provisioned link between a load controller device and a network component is also described herein. The method can include the step of signaling the existence of a disruption in a connection between the load controller device and the network component. The load controller device can be provisioned for the network component and can attempt to connect to the network component when powered up. In response to the disruption, the load controller device can be forced to a peer-to-peer state to clear the provision of the load controller device for the network component. The method can further include the step of transitioning from the peer-to-peer state to a provisioned state to establish a connection between the load controller device and a different network component.

Another load controller device is described herein. The load controller device in this configuration includes a prong configured to engage an external receptacle and receive power therefrom, an internal receptacle configured to engage a load and provide power thereto, a load controller circuit configured to control or monitor the power provided to the load and a communication unit coupled to the load controller circuit and configured to operate in at least a peer-to-peer state and a provisioned state. The load controller device also includes an indicator that can provide an indication as to whether the load controller device is in the peer-to-peer state or the provisioned state. A cover plate can also be part of the load controller device in which the cover plate can contain information to enable a user to interpret the indication provided by the indicator.

Yet another load controller device is described herein. This load controller device can include an electrical interface configured to electrically engage a load and an electrical system of a building and a load controller circuit configured to control or monitor power that is received from the electrical system of the building and provided to the load. This load controller device can also include a communication unit coupled to the load controller circuit and configured to connect with a facilitation module in a peer-to-peer state and connect with a network component in a provisioned state. The communication unit can be further configured to transition the load controller device from the provisioned state to the peer-to-peer state to enable the load controller device to receive initialization information for reestablishment of the connection between the load controller device and the network component or establishment of a connection between the load controller device and a different network component. In one aspect, the electrical interface can electrically engage the load or the electrical system of the building through detachable plugs or through permanent wiring.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example system for state transition of a load controller device in accordance with an embodiment.

FIG. 2 is an illustration of an example load controller device in accordance with an embodiment.

FIG. 3 depicts a flowchart of a method for operating a load controller device in accordance with an embodiment.

FIG. 4 depicts a state diagram that shows various states that a load controller device may enter in accordance with an embodiment.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention. Furthermore, numerous specific details are set forth herein in order to provide a thorough understanding of the described embodiments. However, it will be understood by persons skilled in the relevant art(s) that the embodiments described herein can be practiced without these specific details. In other instances, methods, procedures and components have not been described in detail so as not to obscure the related relevant feature being described. Also, the description is not to be considered as limiting the scope of the embodiments described herein.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Several definitions that apply throughout this document will now be presented. A “load controller device” is defined as a device that controls and/or monitors power being supplied to a load and is configured to communicate with one or more other components in a wired and/or wireless manner. The word “control” means to exercise direction and/or regulation over another component, while the word “monitor” means to observe, record and/or detect. A “load” is defined as an electrical device that is capable of receiving power from a receptacle and that is capable of being in electrical connection with the load controller device. In addition, a “receptacle” is defined as an electrical connector that is configured to receive prongs from a plug, wiring or other structure for the purpose of delivering power to the plug, wiring or other structure. The term “prong” means one or more electrical connectors that are configured to engage a receptacle and to transfer power to a load. The term “load controller circuit” is defined as that part of the load controller device that controls and/or monitors the power provided to the load. The term “communication unit” is defined as that part of the load controller device that is designed to communicate with the other component(s). A “facilitation unit” or “facilitation module” is defined as a device that at least assists another component to complete a connection between that component and a network. The term “network component” is defined as a device that is part of a network, which includes networks that are under the coordination of a central controller as well as networks that have no central controller.

The phrase “peer-to-peer state” is defined as a state in which a load controller device and a facilitation unit have established a connection without a central coordinating device or at least have the capability of establishing a connection without a central coordinating device and the load controller device is not provisioned to a network component. The term “provisioned state” is defined as a state in which a load controller device is provisioned to a network component and in which the load controller device is connected to the network component or at least attempts to connect to the network component. The words “connect,” “connection” or “connected” mean to be coupled such that information is capable of being exchanged (unilaterally or bilaterally) between devices. An “indicator” is defined as a device that generates a sensory signal capable of being detected by humans. Also, a “light source” is a component or a group of components that emit at least some light in the visible spectrum. The term “electrical interface” is defined as a component or a group of components that electrically engage a plug or wiring from a load or electrically engage a plug or wiring of an electrical system of a building. A “detachable plug” is defined as an electrical contact that is configured to permit a user to connect or disconnect an electrical connection through a simple insertion into a receptacle or jack. The term “permanent wiring” is defined as an electrical contact that involves more than temporary coupling of electrical wires.

### B. Example System and Methods for State Transition of a Load Controller Device

As discussed in the Background section above, a Wi-Fi device that has been provisioned to a particular access point (AP) will attempt to connect to that AP when the Wi-Fi device is powered up. Unfortunately, the Wi-Fi device will continue to attempt to connect to the assigned AP, even if that AP has been damaged or otherwise rendered nonoperational. To overcome this issue, a method of facilitating communications between a load controller device and a network component is described herein. The method can include the step of transitioning the load controller device from a peer-to-peer state to a provisioned state. During the peer-to-peer state, the load controller device can receive initialization information, and the initialization information can enable connection to the network component in the provisioned state. If there is a disruption in the connection between the load controller device and the network component in the provisioned state, the load controller device can be forced back to the peer-to-peer state from the provisioned state to enable the load controller device to receive new initialization information for reestablishment of the connection between the load controller device and the network component or for establishment of another connection between the load controller device and a different network component. Moreover, one or more indicators can be selectively activated to enable an operator to determine whether the load controller device is in the peer-to-peer state or the provisioned state.

Such a process can enable the load controller device to re-enter a state that allows for quick and convenient establishment of a connection with another AP in the event the original AP malfunctions. As such, the user of the load controller device is spared from having to reconfigure the new AP, a tedious and somewhat complicated task. Additionally, in view of the selective activation of the indicator(s), the user can quickly ascertain the status of the load controller device.

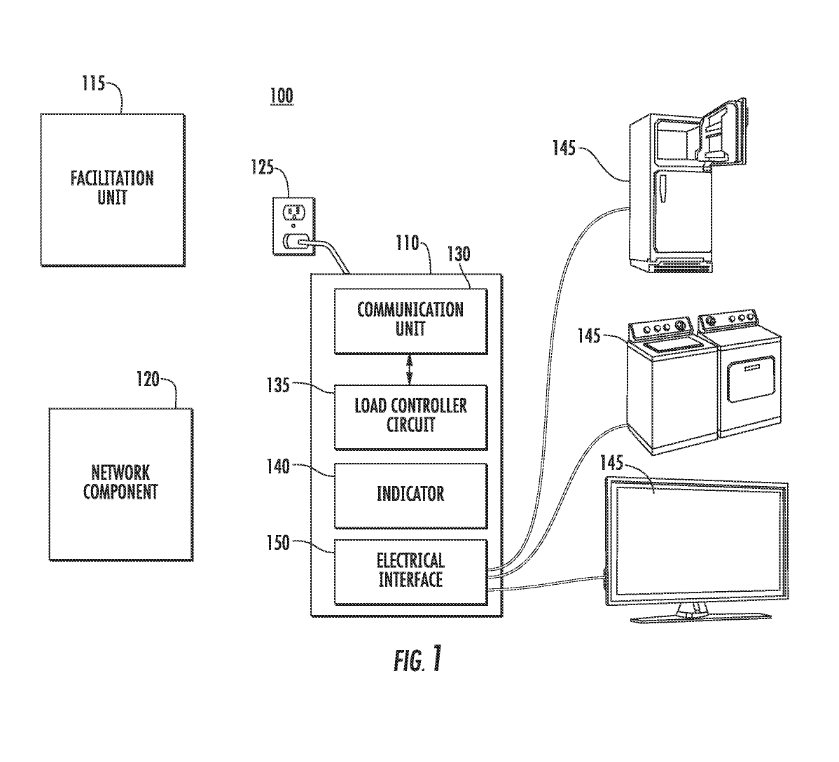

FIG. 1 depicts a block diagram of a communication system 100 in accordance with an embodiment that includes a load controller device 110, a facilitation unit 115, a network component 120 and one or more loads 145. In one arrangement, the load controller device 110 can be engaged with an external receptacle 125 (e.g., an outlet) that provides power, and the load controller device 110 can include an internal receptacle (not shown here) that can engage a load 145 that is configured to receive power from the external receptacle 125. As such, the load controller device 110 can selectively control and/or monitor the amount of power provided to the load 145. Additionally, the load controller device 110 can establish direct communications with the facilitation unit 115, such as in a peer-to-peer mode, and can also exchange communications with the network component 120. As an example, but without limitation, the mode of communications between the load controller device 110 and the network component 120 can be centrally coordinated, although peer-to-peer communications between these two units may also be conducted. As will be explained later, the facilitation unit 115 can assist the load controller device 110 in establishing communications with the network component 120.

The load controller device 110 can include several components. For example, the load controller device 110 can have a communication unit 130, a load controller circuit 135 and an indicator 140. The communication unit 130 can be configured to establish communications with the facilitation unit 115 and the network component 120. For example, the communication unit 130 can be a Wi-Fi transceiver that operates in accordance with any of the IEEE 802.11 standards. Of course, other standards may be employed to operate the communication unit 130, including but not limited to ZigBee (the IEEE 802.15.4 standards) or Bluetooth (IEEE 802.15.1). It follows, then, that the facilitation unit 115 and the network component 120 can both include suitable software and circuitry to operate in accordance with the standards or protocols relied upon by the communication unit 130 of the load controller device 110. It must also be noted that the communication unit 130 can be hard-wired to the facilitation unit 115 and/or the network component 120, if desired. In addition, the facilitation unit 115 can be wirelessly or hard-wired connected with the network component 120, thereby enabling message exchange between the two devices. The facilitation unit 115 can also communicate with the load control device 110 through the network component 120, when a connection is established between the device 110 and the component 120.

The load controller circuit 135 can include any suitable combination of hardware and software for controlling and/or monitoring the amount of power being supplied to the loads 145. For example, the load controller circuit 135 can disconnect a load 145 from its power supply, thereby causing the load 145 to shut off or enter some other reduced power operating state. As another example, the load controller circuit 135 can monitor the energy usage of a particular load 145. To accommodate these features, the load controller circuit 135 can be coupled to the communication unit 130. In particular, instructions can be received at the communication unit 130 from the facilitation unit 115 or the network component 120 and can be forwarded to the load controller circuit 130. Moreover, monitoring information collected by the load controller circuit 130 can be forwarded to the facilitation unit 115 or the network component 120 via the communication unit 130.

As noted earlier, the load controller device 110 can include an indicator 140. The indicator 140 can be any mechanism that generates a sensory signal that can be detected by humans to enable a user to detect changes in the state of the load controller device 110. For example, the indicator 140 can be a light source, an audio source, a vibrational source or any suitable combination of the three. Examples of such sources and how they can inform a user of relevant information about the load controller device 110 will be presented below.

Any suitable load 145 can be coupled to the load controller device 110. Examples include appliances, home entertainment devices and climate-control equipment, although the system 100 is not limited to any of these particular devices. The load controller device 110 can be configured to engage any number of loads 145. Moreover, in one particular arrangement, the load controller device 110 can engage a corresponding number of receptacles 125. It is not necessary, however, for the load controller device 110 to engage an equal number of loads 145 and receptacles 125, as some loads 145 may be able to share a power connection.

The load controller device 110 can also have an electrical interface 150. As noted earlier, the load controller device 110 can include an internal receptacle, which may serve as the electrical interface 150. Through the use of a receptacle, loads 145 can be easily coupled to and decoupled from the load controller device 110 through the use of detachable plugs. Alternatively, the interface 150 can be a collection of wiring and circuitry that can enable the load controller device 110 to be permanently wired to a load 145. Any suitable number of loads 145 can be coupled to the load controller device 110, either through an internal receptacle, permanent wiring or a combination of both.

In addition to being coupled with the load(s) 145, the electrical interface 150 can be coupled to the external receptacle 125. As pictured, this coupling can be through the use of detachable electrical plugs or prongs (not shown here), which can allow for quick and easy installation. Nevertheless, like the coupling with the load(s) 145, the electrical interface 150 can be permanently wired to a building's electrical system. When compared to the external receptacle 125 configuration, such a design may be safer for a user, as exposed wiring or contacts may be nonexistent.

Although not pictured in FIG. 1, the load controller device 110 may be equipped with other components to obtain information about the environment surrounding the device 110. For example, the load controller device 110 can contain a temperature sensor to obtain the temperature of the device 110 or the surrounding area. As another example, the load controller device 110 may include an ambient light sensor or a microphone for detecting sounds in the area. Of course, the load controller device 110 is not limited to these examples, as it may be outfitted with other components.

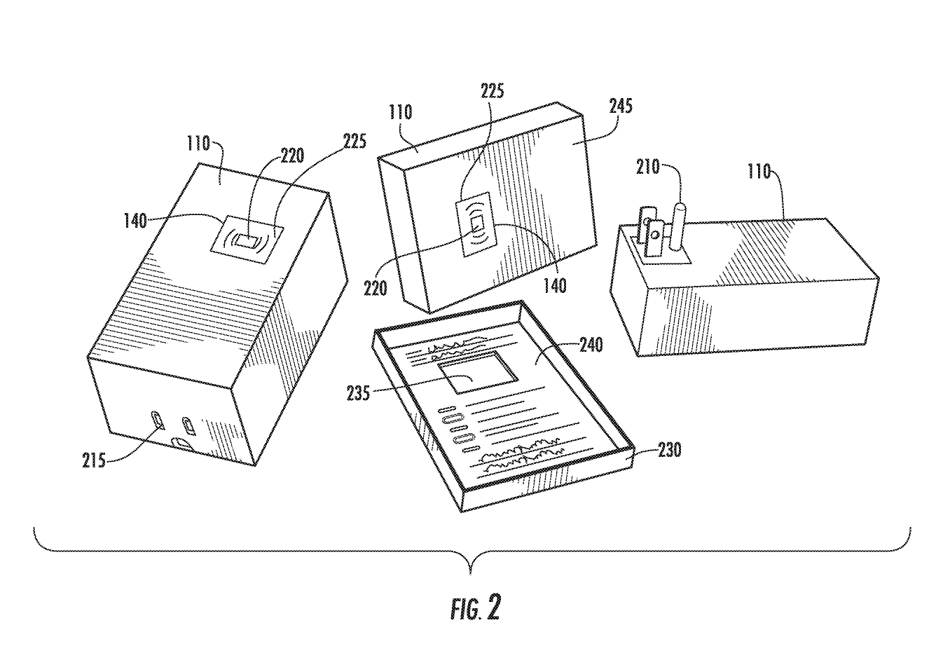

Referring now to FIG. 2, one example of a load controller device 110 is illustrated. In this exemplary structure, the load controller device 110 can include one or more prongs 210 configured to detachably engage the external receptacle 125 (see FIG. 1) and can have one or more internal receptacles 215. The internal receptacle 215 can detachably engage one or more plugs of the loads 145. Although in this example, the load controller device 110 is shown as having a receptacle 215 for engaging a load 145, a load 145 can also be permanently wired to the load controller device 110, as was described earlier. In addition, the set of prongs 210 is not necessarily required to have a ground connection. As was also previously noted, the load controller device 110 can be permanently wired to a building's electrical system, which can eliminate the need for the prongs 210. For example, the load controller device 110 can be permanently wired to a pump, an air conditioning or heating unit, a water heater or some other large load and directly tied into the building's electrical system.

An example of the indicator 140 is also pictured in FIG. 2. In particular, the indicator 140 can be one or more light sources 220. For example, the light source 220 can be comprised of one or more light emitting diodes (LED), and in this example, the light source 220 is capable of generating light of various colors. Moreover, the light source 220 can emit light in accordance with one or more predetermined illumination patterns. By varying light color and illumination patterns, the light source 220 can be selectively illuminated to enable a user of the load controller device 110 to determine a state or condition of the load controller device 110. It is understood, however, that the light source 220 is not limited to one or more LEDs. Additionally, the indicator 140 can be in the form of something other than a light source. For example, the indicator 140 can be an audio generator, which can selectively broadcast one or more sounds to allow a user to detect a state or condition of the load controller device 110. Likewise, the indicator 140 can be a device that generates one or more vibrations, such as a predetermined pattern of vibrations, for determining a condition of the load controller device 110.

The load controller device 110 can also include a switch 225, which, when activated, can cause the load controller device 110 to enter a different operational state. For example, the switch 225 can be pressed by a user to force the load controller device 110 to be forced to a peer-to-peer state from a provisioned state. Alternatively, the load controller device 110 or some other component can automatically activate the switch 225 or some other suitable element to cause the load controller device 110 to transition back to the peer-to-peer state or some other operational state. The switch 225 can also be activated to cause the indicator 140 to provide a status check to enable a user to determine the state of the load controller device 110. For example, if the switch 225 is depressed for less than a predetermined time period, the light source 220 can illuminate in accordance with a certain color or pattern. If the switch 225 is depressed for more than the predetermined time period, however, the switch 225 can cause the load controller device 110 to transition to a different state.

In one arrangement, the load controller device 110 can include a cover plate 230, which can fit over the device 110. The load controller device 110 and the cover plate 230 can be fitted with any suitable structure to ensure that the cover plate 230 can be secured to the device 110. As an example, the cover plate 230 can be snap fitted onto the load controller device 110 and can be easily removed from the device 110. The cover plate 230 can include a slot 235 that can fit over the switch 224 and the indicator 140 when the cover plate 230 is engaged with the load controller device 110.

The cover plate 230 can also have an inside surface 240, and relevant information about the load controller device 110 can be placed on the inside surface 240. In addition to or in lieu of the inside surface 240, information can be placed on an outside surface 245 of the cover plate 230. This information can be, for example, written in by a user by hand or by some other machine. As an example, the relevant information can include the location in which the device 110 will be placed and the load 145 that will be engaged with the device 110. As another example, information about the connection between the load controller device 110 and the network component 120 may be placed on the inside surface 240 and/or the outside surface 245. As explained earlier, the indicator 140 may be a light source 220. In this case, the information on the inside surface 240 and/or the outside surface 245 can also include a chart or some other guide that explains what the various colors and illumination patterns exhibited by the light source 220 mean. Of course, various other types of information may be placed on the inside surface 240 and/or the outside surface 245, as these examples are not meant to be limiting. Further, the information can be placed on other suitable locations on the load controller device 110, on some other location near the device 110 or displayed on another device.

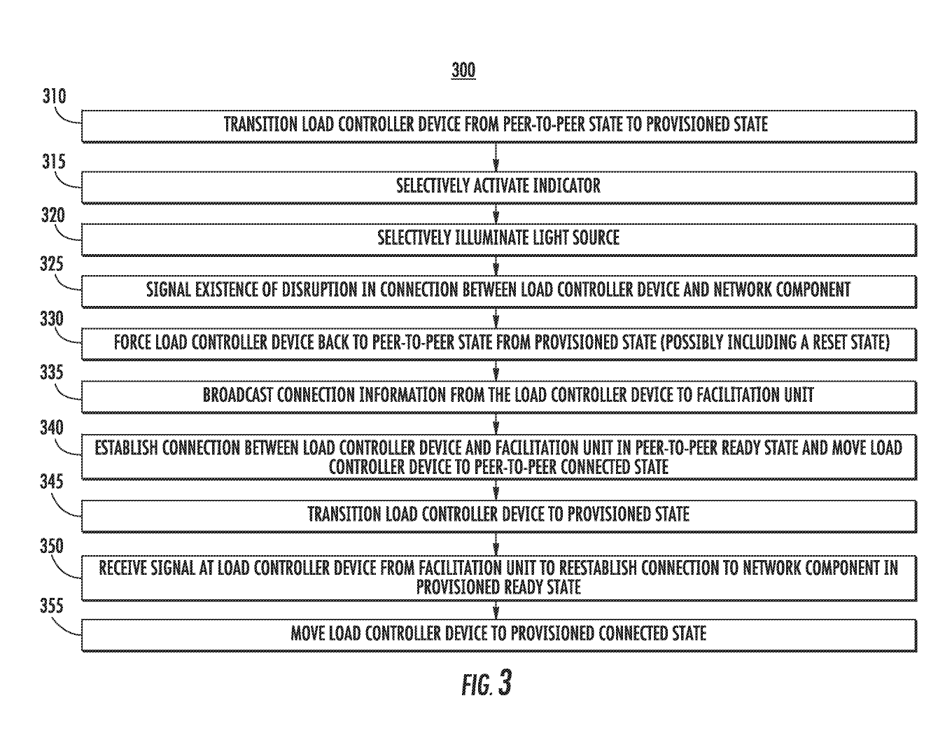

Referring to FIG. 3, a flowchart 300 of a method of operating a load controller device is shown. In describing the method of flowchart 300, reference may be made to FIGS. 1 and 2, although other devices and systems may be used to practice the method. Moreover, the steps of the method of flowchart 300 are not necessarily limited to the particular chronological order shown here. The method of flowchart 300 may also contain a greater number of or even a fewer number of steps, as compared to that shown in FIG. 3.

As shown in FIG. 3, the method of flowchart 300 begins at step 310, in which a load controller device capable of wireless communications with a network component can be transitioned from a peer-to-peer state to a provisioned state. In addition, an indicator can be selectively activated as shown at step 315, which can enable an operator to determine whether the load controller device is in the peer-to-peer state or the provisioned state. As an example, a light source can be selectively illuminated using one or more illumination patterns or colors to enable the user to distinguish between these states, as shown at step 320. At step 325, the existence of a disruption in a connection between the load controller device and the network component can be signaled. At step 330, the load controller device can be forced back to the peer-to-peer state—including possibly a reset state—from the provisioned state, which can assist in the reestablishment of the connection with the original network component or a different network component.

As part of this process, connection information can be broadcast from the load controller device to a facilitation unit, as shown at step 335. Subsequently, at step 340, a connection can be established between the load controller device and the facilitation unit in a peer-to-peer ready state, and the load controller device can be moved to a peer-to-peer connected state. Eventually, at step 345, the load controller device can be transitioned back to the provisioned state. In particular, a signal can be received at the load controller device from the facilitation unit to reestablish a connection with a network component in a provisioned ready state, as shown at step 350. Finally, at step 355, the load controller device can be moved to a provisioned connected state when the connection is established.

Referring to FIGS. 1 and 2, an example of this process will now be explained. The load controller device 110 can be transitioned from a peer-to-peer state to a provisioned state. During the peer-to-peer state, the load controller device 110 can receive initialization information, which can enable connection to the network component 120 in the provisioned state. As an example, the load controller device 110 can be connected to the facilitation unit 115, which can send the initialization information to the load controller device 110. The term “initialization information” is defined as information of which at least a portion is used to enable a load controller device to connect with a network component, and examples may include parameters like service set identifier (SSID), channel, security method and security passkey. In another aspect, the initialization information may include user or operator parameters that would be helpful to a user in identifying a load controller device and its location. For example, the user can designate the load controller device 110 with a name and can list its location and the load(s) 145 to which it is engaged. Of course, these parameters are merely exemplary in nature, and other types of information can form part of the initialization information. In one arrangement, the initialization information can be entered into the facilitation unit 115, and at least some of it can be sent to the load controller device 110.

From here, the load controller device 110 can establish a connection with the network component 120. The user of the load controller device 110 can also be made aware of the progress of this transition by selective activation of the indicator 140. For example, if the indicator 140 is the light source 220, the light source 220 can illuminate in a certain color and/or pattern to inform the user when the load controller device 110 is in the peer-to-peer state and the provisioned state.

At some point, however, there may be a disruption in the connection between the load controller device 110 and the network component 120. For instance, the network component 120 may be damaged such that it cannot maintain or reestablish a connection with the load controller device 110. The light source 220, through a particular color and/or light pattern, can also signal the user of this disruption in the connection between the load controller device 110 and the network component 120. Here, the load controller device 110 can be forced back to the peer-to-peer state. The load controller device 110 can automatically move back to the peer-to-peer state, or the user can simply activate the switch 225 or some other suitable element to cause this transition of forced move.

In view of this forced transition, the connection between the load controller device 110 and the network component 120 can be reestablished, or another connection can be established between the load controller device 110 and a different network component 120. This feature can be realized because the load controller device 110 can receive initialization information for the original network component 120 or the different network component 120 in the peer-to-peer state. If the load controller device 110 were to simply stay in the provisioned state, the load controller device 110 would continue to attempt to (unsuccessfully) reconnect with the damaged or non-operational network component 120.

In one arrangement, the peer-to-peer state can include more than one state. For example, the peer-to-peer state can include a peer-to-peer ready state and a peer-to-peer connected state. When the load controller device 110 enters the peer-to-peer ready state, the load controller device 110 can broadcast connection information to the facilitation unit 115, and a connection can be established between these components. Next, the load controller device 110 can enter the peer-to-peer connected state, where new initialization information can be received at the load controller device 110 from the facilitation unit 115. The new initialization information can include updated information for the original network component 120, such as a new channel assignment, or new information for the different network component 120. The indicator 140 can also be used to apprise a user as to whether the load controller device 110 is in either one of these states.

As an option, the peer-to-peer state can include another state called the reset state. The load controller device 110 can be placed in the reset state from the peer-to-peer ready state, such as by activating the switch 225 for longer than a predetermined time period. In the reset state, all or at least a portion of the initialization information can be deleted from the load controller device 110. This procedure may be useful if the user wishes to add new or updated user parameters to the device 110. Again, the user can be informed of the reset state entry by the indicator 140. Once the relevant initialization information is deleted in the reset state, the load controller device 110 can re-enter the peer-to-peer ready state followed by its eventual transition to the peer-to-peer connected state.

After it reaches the peer-to-peer connected state, the facilitation unit 115, for example, can signal the load controller device 110 to enter the provisioned state. In the provisioned state, the device 110, in receipt of the new or updated initialization information, can establish a connection with the original or different network component 120. That is, the load controller device 110 can be provisioned for a specific network component 120 in this state. In one arrangement, the provisioned state can include a provisioned ready state and a provisioned connected state. In the provisioned ready state, the load controller device 110 can attempt to connect with the appropriate network component 120. The device 110 can be set to attempt the connection for a predetermined number of times. If the number of unsuccessful attempts exceeds the predetermined number, then the load controller device 110 can enter an error state. From there, the device 110 can again be forced back to, for example, the provisioned state, such as the provisioned ready state, during which the device 110 can continue to attempt to establish the connection. The indicator 140 can provide a status update based on these state transitions.

If the load controller device 110, however, establishes the connection within the predetermined number of attempts, the device 110 can then move to the provisioned connected state. Similarly, if the device 110 successfully completes the connection after returning to the provisioned ready state from the error state, the device 110 can transition to the provisioned connected state. Here, the facilitation unit 115 can communicate with the load controller device 110 through the network component 120. Because it may be part of a centrally-coordinated network, the network component 120 can ensure synchronized communications with the device 110. Further, other devices other than the facilitation unit 115 may be able to exchange messages with the load controller device 110 through the network component 120. As such, the facilitation unit 115 or some other suitable component can request, receive and display information concerning the load controller device 110 and the load(s) 145. The facilitation unit 115 or another component can also display user interface elements to allow the user to control the operation of the load controller device 110, and, hence, the load(s) 145 engaged with the device 110.

In view of this arrangement, in the provisioned connected state, the user can glean information about the energy usage of the load(s) 145 and/or can control such usage. For example, the user can view the amount of energy consumed by a load 145, the overall history of energy consumption for that load 145, the efficiency of the load 145 and the expense involved in its operation. The user can also take steps to control the operation of the load 145 by manipulating one or more user interface elements of the facilitation unit 115. For example, the user can direct the load controller device 110 to shut down a load 145 for a predetermined amount of time to conserve energy. In one arrangement, when such monitoring or controls are executed, the load controller device 110 may enter an event state, which can also be part of the provisioned state. Similar to previous descriptions, the indicator 140 can provide an indication as to when the load controller device 110 enters any one of these states. Also, if desired, the load controller device 110 can be forced back to the peer-to-peer state from the provisioned connected state, the provisioned ready state or the event state.

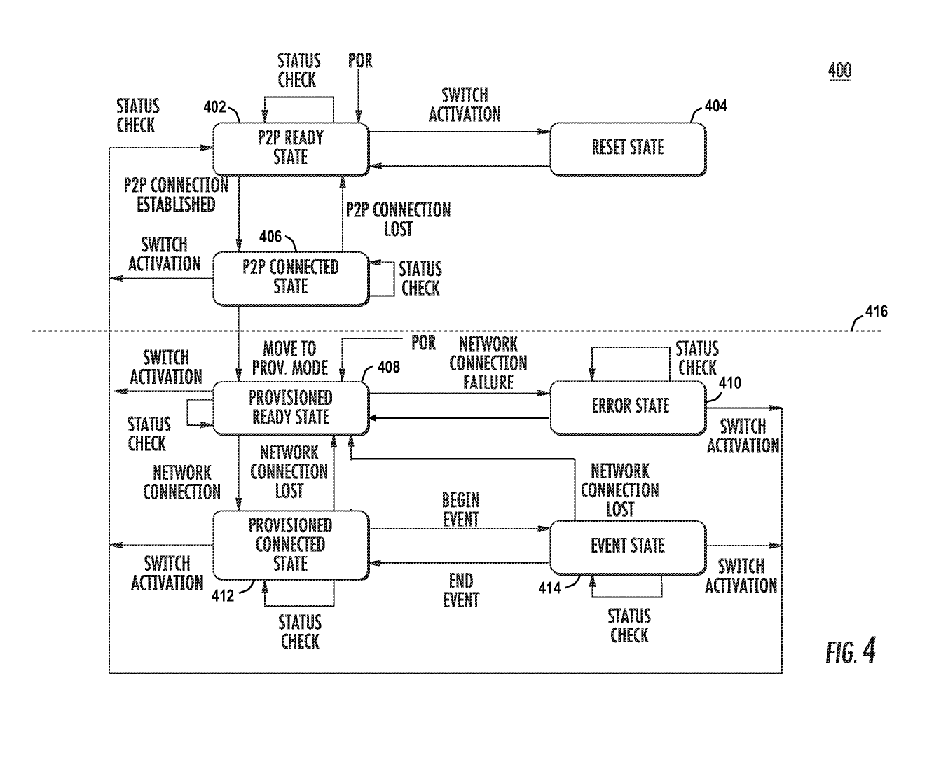

FIG. 4 depicts a state diagram 400 that includes examples of various states that a load controller device in accordance with an embodiment may enter. To help explain the state diagram 400, reference will again be made to FIGS. 1 and 2, although other suitable components and systems may operate in accordance with the diagram 400. Moreover, a load controller device operating in accordance with the state diagram 400 is not necessarily required to enter all the states shown therein, and such a load controller device may also enter states other than those pictured therein. For reference, a dashed line 416 running horizontally along the diagram 400 represents a demarcation in the diagram 400 in which the states above the line 416 are associated with the peer-to-peer state and those below the line 416 are associated with the provisioned state.

Referring to peer-to-peer (P2P) ready state 402, a load controller device 110 being powered up or reset (POR) may initially be set in a peer-to-peer mode in which it is configured to attempt to establish a peer-to-peer connection with another component, such as the facilitation unit 115. In this state and the others, a status check refers to the process of a user pressing on the switch 225 under a predetermined time period to determine that state of the load controller device 110. A status check, however, could automatically be initiated by the load controller device 110 without any user intervention. A switch activation refers to the user pressing on the switch 225 for an amount of time greater than the predetermined time period, which may cause the load controller device 110 to transition to another state. The switch activation may also be automatically triggered by the load controller device 110 or some other unit in communications with the device 110.

The following are some exemplary characteristics of the load controller device 110 in the P2P ready state 402: (1) initial state after power on in the peer-to-peer state; (2) not provisioned for a specific network component 120; (3) not connected to a network component 120; (4) allows peer-to-peer communication to other devices, like the facilitation unit 115, in an ad-hoc mode or some other method; (5) status check causes the light source 220 to illuminate in a first color/pattern combination for a predetermined time; and (6) switch activation causes device 110 to enter reset state 404.

As noted above, switch activation causes the load controller device 110 to enter the reset state 404. The following are some exemplary characteristics of the load controller device 110 in the reset state 404: (1) clears initialization information, including user parameters; (2) once initialization information cleared, can transition back to P2P ready state; and (3) accessible from P2P ready state 402.

If the load controller device 110 successfully connects with the facilitation unit 115, then the device can transition to the P2P connected state 406. The following are some exemplary characteristics of the load controller device 110 in this state: (1) not provisioned for a specific network component 120; (2) not connected to a network component 120; (3) connected via peer-to-peer communication to the facilitation unit 115 or some other device using an ad-hoc mode or some other method; (4) able to receive initialization information, including user parameters; (5) if peer-to-peer communication with facilitation unit 115 is lost, can move back to P2P ready state 402; (6) status check causes the light source 220 to illuminate in a second color/pattern combination for a predetermined time; (7) switch activation causes load controller device 110 to move back to P2P ready state 402.

From the P2P connected state 406, the load controller device 110 can transition to the provisioned ready state 408. This is made possible, at least in part, because the device 110 has received the new (including updated) initialization information while in the P2P connected state 406. Once the load controller device 110 has been provisioned, the device 110 can enter the provisioned ready state 408 at power-up or reset (POR), as indicated by the POR arrow leading into the provisioned ready state 408 box. The following are some exemplary characteristics of the load controller device 110 in the provisioned ready state 408: (1) initial state after power on in the provisioned state; (2) provisioned for a specific network component 120; (3) not connected to a network component 120; (4) attempts to connect to network component 120 for a predetermined number of times; (5) moves to provisioned connected state 412 if attempt to connect to network component 120 is successful; (6) moves to error state 410 if attempt to connect to network component 120 is unsuccessful; (7) status check causes the light source 220 to illuminate in a third color/pattern combination for a predetermined time; and (8) switch activation causes load controller device 110 to move back to P2P ready state 402.

If the load controller device 110 successfully connects to the network component 120 and the number of attempts is less than or equal to the predetermined number, the device 110 can transition to the provisioned connected state 412. Here, the device 110 is connected to the network component 120 and various other components, such as the facilitation unit 115, can control or exchange messages with the device 110. The following are some exemplary characteristics of the load controller device 110 in this state: (1) provisioned for a specific network component 120; (2) connected to a network component 120; (3) allows facilitation unit 115 to program user data, change on/off state of a load 145, query energy usage data and query temperature data concerning the environment around the load controller device 110; (4) if connection lost with network component 120, moves back to provisioned ready state 408; (5) move to event state 414 if load controller device 110 required to control and/or monitor load 145; (6) status check causes the light source 220 to illuminate in a fourth color/pattern combination for a predetermined time; (7) switch activation causes load controller device 110 to move back to P2P ready state 402; and (8) load controller device 110 is discoverable, such that the facilitation unit 115 can locate and connect to the load controller device 110.

If the load controller device 110, however, does not establish a connection with the network component 120 within the predetermined number of attempts, the device 110 can transition to the error state 410. After entering the error state 410, the device 110 can again be forced back to the provisioned ready state 408, during which the device 110 may continue to attempt to connect to the network component 120. The following are some exemplary characteristics of the load controller device 110 in the error state 410: (1) provisioned for a specific network component 120; (2) not connected to network component 120; (3) status check causes the light source 220 to illuminate in a fifth color/pattern combination for a predetermined time; and (4) switch activation causes load controller device 110 to move back to P2P ready state 402.

As noted earlier, when in the provisioned connected state 412, the load controller device 110 may receive queries or control instructions from the facilitation unit 115. In response, the device 110 may enter the event state 414. The following are some exemplary characteristics of the load controller device 110 in this state: (1) provisioned for a specific network component 120; (2) connected to a network component 120; (3) allows facilitation unit 115 to program user data, change on/off state of a load 145, query energy usage data and query temperature data; (4) if connection is lost with network component 120, moves back to provisioned ready state 408; (5) once the event (query or control instruction) is complete, returns to provisioned connected state 412; (6) status check causes the light source 220 to illuminate in a sixth color/pattern combination for a predetermined time; and (7) switch activation causes load controller device 110 to move back to P2P ready state 402.

It must be stressed that the preceding description is exemplary in nature, as the load controller device 110 is not necessarily limited to these particular states. In addition, the device 110 is not limited to the characteristics ascribed to each of the states. In fact, the listing of characteristics recited here is not meant to be exhaustive or limiting in any way, and other suitable features may be associated with each of the states of the load controller device 110.

### C. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. In a load controller device capable of communicating with a network component, a method of facilitating communications between the load controller device and the network component, comprising:
transitioning the load controller device from a peer-to-peer state in which the load controller device receives initialization information to a provisioned state in which the load controller device establishes a connection to the network component using the initialization information; and
in response to a disruption in the connection between the load controller device and the network component in the provisioned state, forcing the load controller device back to the peer-to-peer state from the provisioned state to enable the load controller device to receive new initialization information for reestablishment of the connection between the load controller device and the network component or for establishment of a connection between the load controller device and a different network component.

2. The method according to claim 1, further comprising transitioning the load controller device to the provisioned state for connection to the network component or the different network component following the receipt of the new initialization information by the load controller device.

3. The method according to claim 1, further comprising selectively activating an indicator to enable an operator to determine whether the load controller device is in the peer-to-peer state or the provisioned state.

4. The method according to claim 3, wherein selectively activating the indicator includes selectively illuminating a light source in which one or more illumination patterns or colors are used to enable the operator to distinguish between the peer-to-peer state and the provisioned state.

5. The method according to claim 1, wherein the peer-to-peer state comprises a reset state, a peer-to-peer ready state and a peer-to-peer connected state.

6. The method according to claim 5, wherein forcing the load controller device back to the peer-to-peer state from the provisioned state further comprises forcing the load controller device to the reset state to delete initialization information of the load controller device.

7. The method according to claim 5, further comprising broadcasting connection information from the load controller device to a facilitation unit when the load controller device is in the peer-to-peer ready state.

8. The method according to claim 7, further comprising:
establishing a connection between the load controller device and the facilitation unit while the load controller device is in the peer-to-peer ready state; and
when the load controller device is connected to the facilitation unit, moving the load controller device to the peer-to-peer connected state and receiving the new initialization information from the facilitation unit in the peer-to-peer connected state.

9. The method according to claim 1, wherein the provisioned state comprises a provisioned ready state and a provisioned connected state.

10. The method according to claim 9, further comprising receiving a signal at the load controller device from a facilitation unit directing the load controller device to reestablish the connection to the network component in the provisioned ready state or establish the other connection to the different network component in the provisioned ready state.

11. The method according to claim 10, further comprising moving the load controller device to the provisioned connected state when the connection between the load controller device and the network component is reestablished or when the connection between the load controller device and the different network component is established.

12. The method according to claim 1, wherein the load controller device engages an outlet and a load that is configured to receive power from the outlet, wherein the load controller device selectively controls or monitors the amount of power provided to the load.

13. A load controller device, comprising:
a prong configured to engage an external receptacle and receive power therefrom;
an internal receptacle configured to engage a load and provide power thereto;
a load controller circuit configured to control or monitor the power provided to the load; and
a communication unit coupled to the load controller circuit and configured to connect with a facilitation module in a peer-to-peer state and connect with a network component in a provisioned state;
wherein the communication unit is further configured to transition the load controller device from the provisioned state to the peer-to-peer state to enable the load controller device to receive initialization information for reestablishment of a connection between the load controller device and the network component or establishment of a connection between the load controller device and a different network component.

14. The load controller device according to claim 13, wherein the communication unit is further configured to transition the load controller device from the provisioned state to the peer-to-peer state if there is a disruption in the connection between the communication unit and the network component.

15. The load controller device according to claim 13, further comprising an indicator configured to alert a user as to whether the load controller device is in the peer-to-peer state or the provisioned state.

16. The load controller device according to claim 15, wherein the indicator is a light source and the light source is selectively illuminated in accordance with a predetermined pattern to enable the user to distinguish between the peer-to-peer state and the provisioned state.

17. The load controller device according to claim 13, wherein the communication unit is further configured to broadcast connection information about the load controller device when the load controller device is in the peer-to-peer state.

18. The load controller device according to claim 17, wherein the peer-to-peer state comprises a peer-to-peer ready state and a peer-to-peer connected state and wherein the communication unit broadcasts the connection information in the peer-to-peer ready state and is connected to the facilitation module in the peer-to-peer connected state.

19. The load controller device according to claim 18, wherein the initialization information is received by the load controller device in the peer-to-peer connected state.

20. The load controller device according to claim 13, wherein the provisioned state comprises a provisioned ready state and a provisioned connected state and wherein the load controller device attempts to connect to the network component or the different network component in the provisioned ready state and is connected to the network component or the different network component in the provisioned connected state.

21. The load controller device according to claim 13, further comprising a switch, wherein activating the switch causes the communication unit to transition the load controller device from the provisioned state to the peer-to-peer state.

22. A method of interrupting a provisioned link between a load controller device and a network component, comprising:
signaling the existence of a disruption in a connection between the load controller device and the network component, wherein the load controller device is provisioned for the network component and attempts to connect to the network component when powered up; and
in response to the disruption, forcing the load controller device to a peer-to-peer state to clear the provision of the load controller device for the network component.

23. The method according to claim 22, further comprising transitioning from the peer-to-peer state to a provisioned state to establish a connection between the load controller device and a different network component.

24. A load controller device, comprising:
a prong configured to engage an external receptacle and to receive power therefrom;
an internal receptacle configured to engage a load and to provide power thereto;
a load controller circuit configured to control or monitor the power provided to the load;
a communication unit coupled to the load controller circuit and configured to operate in at least a peer-to-peer state and a provisioned state;
an indicator that provides an indication as to whether the load controller device is in the peer-to-peer state or the provisioned state; and
a cover plate, wherein the cover plate contains information to enable a user to interpret the indication provided by the indicator.

25. A load controller device, comprising:
an electrical interface configured to electrically engage a load and an electrical system of a building;
a load controller circuit configured to control or monitor power that is received from the electrical system of the building and provided to the load; and
a communication unit coupled to the load controller circuit and configured to connect with a facilitation module in a peer-to-peer state and connect with a network component in a provisioned state;
wherein the communication unit is further configured to transition the load controller device from the provisioned state to the peer-to-peer state to enable the load controller device to receive initialization information for reestablishment of the connection between the load controller device and the network component or establishment of a connection between the load controller device and a different network component.

26. The load controller device according to claim 25, wherein the electrical interface electrically engages the load or the electrical system of the building through detachable plugs or through permanent wiring.
